(19) United States
(12) Patent Application Publication
(10) Pub. No.: US 2014/0247483 A1
(43) Pub. Date: Sep. 4, 2014

(54) SIGHTING APPARATUS CAPABLE OF DISPLAYING COMPENSATION POSITION

(71) Applicants: SINTAI OPTICAL (SHENZHEN) CO., LTD., Shenzhen City (CN); ASIA OPTICAL INTERNATIONAL LTD., Tortola (GB)

(72) Inventors: Shang Yung LIANG, Shenzhen City (CN); Chia-chi TANG, Shenzhen City (CN); Tung-ching CHEN, Shenzhen City (CN)

(73) Assignees: ASIA OPTICAL INTERNATIONAL LTD., Tortola (GB); SINTAI OPTICAL (SHENZHEN) CO., LTD., Shenzhen City (CN)

(21) Appl. No.: 14/276,081

(22) Filed: May 13, 2014

Related U.S. Application Data
(63) Continuation-in-part of application No. 13/865,167, filed on Apr. 17, 2013.
Application No. 13/865,167 is a continuation of application No. 12/573,082, filed on Oct. 2, 2009, now abandoned.

(30) Foreign Application Priority Data
Dec. 12, 2008 (TW) 097148344

(51) Int. Cl. G02B 23/00

(52) U.S. Cl. CPC G02B 23/145
USPC 359/432

(57) ABSTRACT

A sighting apparatus for displaying compensation position is described. The sighting apparatus includes a magnification adjustment module; a magnification generation module, which comprises a magnification pattern for undergoing a movement of the magnification pattern, and a sensing unit for detecting the magnification pattern to obtain a current magnification value; a display unit, for displaying the target in a reference position of the displaying unit when the sighting apparatus sights the target; and a controller coupled to the magnification generation module and the display unit respectively, for acquiring a first compensation position based on a range distance of the target, and for computing a ratio of the current magnification value and a predetermined magnification value of the sighting apparatus, wherein the controller generates a second compensation position based on the first compensation position and the ratio for displaying the second compensation position in the display unit.

### CROSS REFERENCE TO RELATED APPLICATION

This is a continuation-in-part of U.S. patent application Ser. No. 13/865,167, which was filed on Apr. 17, 2013, and which is a continuation of now-abandoned U.S. patent application Ser. No. 12/573,082, which was filed on Oct. 2, 2009, and which in turn claimed priority to Taiwan Patent Application No. 097148344, which was filed on Dec. 12, 2008. The contents of the foregoing are all incorporated herein by reference in their entirety.

### FIELD OF THE INVENTION

The present invention relates to a sighting apparatus, and more particularly to a sighting apparatus that displays a compensation position in a field of vision of the sighting apparatus and is applicable to a laser sight and a rangefinder.

### BACKGROUND OF THE INVENTION

FIG. 1 of the attached drawings shows a schematic view of a conventional sighting apparatus, generally designated at 100. The conventional sighting apparatus 100 generally comprises a sighting tube 102, a magnification adjustment ring 104 and, an array of values of magnification 106. The magnification adjustment ring 104 is mounted on the sighting tube 102, serving as a rotary mechanism to be operated by a user to select and adjust the magnification value of the sighting apparatus 100. The magnification adjustment ring 104 is provided with indications showing multiple values of magnification, such as 3, 4, . . . , 9, to serve an indication and selection by a user for setting the magnification of the sighting apparatus 100. To operate, the magnification adjustment ring 104 is rotated to change the magnification values 106 so that the user may visually identify the current magnification value applied to the sighting apparatus 100. When a user sights at an instant target through the sighting tube 102, the user often adjusts the magnification at the same time when he or she is observing the instant target with the sighting tube 102 in order to correctly aim at the target. Under this situation, the user's eyesight must frequently leave the sighting tube 102 to visually check the magnification values 106 that are provided on the magnification adjustment ring 104 in order to get aware of the current magnification value of the sighting apparatus 100. This makes it difficult to precisely adjust the magnification adjustment ring 104 to the desired magnification value 106, and apparently, the operation is awkward. Further, the compensation position of the target cannot be displayed in the display unit. In view of this problem, it is desired to develop a novel sighting apparatus that overcomes the above described problem.

### SUMMARY OF THE INVENTION

Another object of the present invention is to provide a sighting apparatus, which is capable of immediately displaying the displaying compensation position in a field of vision of the sighting apparatus, whereby convenience of sighting can be enhanced.

Another object of the present invention is to provide a sighting apparatus, which is capable of immediately displaying the magnification value in a field of vision of the sighting apparatus in order to eliminates the problem that a user must removes his or her eye from a field of vision of an existing sighting apparatus, whereby precision of sighting can be enhanced.

To achieve the above objects, in accordance with the present invention, a sighting apparatus capable of displaying magnification is provided, comprising a magnification generation module, a controller, a display unit, and a magnification adjustment module. The sighting apparatus is mounted on a sighting tube. The magnification generation module is couple to the magnification adjustment module of the sighting apparatus. The magnification generation module comprises a magnification pattern and a sensing unit. The magnification pattern contains a plurality of magnification values. When the magnification generation module is being adjusted, the magnification pattern undergoes a corresponding change of the magnification value in response to the adjustment of the magnification adjustment module, whereby the sensing unit detects the magnification pattern and obtains a current magnification value among the magnification values. The sensing unit generates a magnification signal corresponding to the current magnification value. The controller transforms the magnification signal. The display unit receives the transformed magnification signal and displays the current magnification value. The magnification pattern comprises a plurality of magnification sections, each corresponding to one magnification value. The magnification pattern and the magnification adjustment module are set in synchronization with each other for the operations thereof.

In a first embodiment, each of the magnification sections comprises a plurality of electrode zones. The sensing unit comprises a plurality of electrically conductive portions and each electrically conductive portion is set in electrical engagement with a respective electrode zone of the magnification sections, whereby the electrically conductive portions detect the magnification signal. The magnification pattern is constructed as an electrically conductive ring.

In a second embodiment, each of the magnification sections comprises a plurality of light/shade areas. The sensing unit comprises a plurality of light detection elements. Each light detection area corresponds to a respective light/shade area of each magnification section, whereby the light detection elements detect the magnification signal. The magnification pattern is constructed as a disc-shaped layer of material. In a third embodiment, the magnification pattern is constructed as a rectangular layer of material forming a circumferential ring of patterns, wherein the light detection elements of the second embodiment may be employed to detect the light/shade areas of the rectangular layer of material.

In a fourth embodiment, the sighting apparatus for sighting a target comprises a magnification adjustment module, which is operated for adjusting magnification of the sighting apparatus; a magnification generation module, which comprises a magnification pattern for undergoing a movement of the magnification pattern in response to the operation of the magnification adjustment module, and a sensing unit for detecting the magnification pattern to obtain a current magnification value and generates a magnification signal corresponding to the current magnification value; a display unit, for displaying the target in a reference position of the displaying unit when the sighting apparatus sights the target; and a controller coupled to the magnification generation module and the display unit respectively, for acquiring a first compensation position based on a range distance of the target, and for computing a ratio of the current magnification value and a predetermined magnification value of the sighting apparatus, wherein the controller generates a second compensation position based on the first compensation position and the ratio for displaying the second compensation position in the display unit.

In one embodiment, the magnification pattern and the magnification adjustment module are synchronously movable with each other, and the magnification adjustment module comprises a rotatable magnification adjustment ring. The magnification pattern comprises a plurality of magnification sections, each corresponding to a value of the magnification. Each of the magnification sections comprises a plurality of electrode zones. The magnification pattern comprises an electrically conductive ring. The sighting apparatus further comprises a controller coupled to the magnification generation module for transformation of the magnification signal corresponding to the current magnification value without displaying in a display unit. The sighting apparatus further comprises a display unit, which displays the current magnification value corresponding to the magnification signal, wherein the display unit is disposed on an optical focal plane of the sighting apparatus.

In one embodiment, the sighting apparatus further comprises a range-measuring device, for measuring a range distance from the sighting apparatus to the target; and a magnification-reading device, for reading the current magnification value of the sighting apparatus in the reference position when an image of the target is either magnified or minified, and for reading a predetermined magnification value of the sighting apparatus. The controller multiplies the first compensation position by the ratio for shifting the image of the target from the reference position to the second compensation position in the display unit.

Based on the above description, the sighting apparatus capable of displaying magnification as provided by the present invention comprises a magnification generation module that comprises a magnification pattern and a sensing unit. The sensing unit functions to detect the magnification pattern in order to obtain a current magnification value among those magnification values for immediate display of the current magnification value in a field of vision of the sighting apparatus. In this way, the problem that a user must remove his or her eye from the field of vision of an existing sighting apparatus in order to get aware of the magnification value is completely overcome. Further, the sighting apparatus is capable of immediately displaying the displaying compensation position in a field of vision of the sighting apparatus, whereby convenience of sighting can be enhanced.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic view illustrating a conventional sighting apparatus;

FIG. 2 is a cross-sectional view of a sighting apparatus capable of displaying magnification according to a first embodiment of the present invention;

FIG. 3 is a schematic view illustrating a field of vision of the sighting apparatus of FIG. 2 according to the present invention;

FIG. 4 is a block diagram of the sighting apparatus capable of displaying magnification according to an embodiment of the present invention;

FIG. 5 is a schematic view showing a magnification pattern of a magnification generation module according to a first embodiment of the present invention;

FIG. 6A is a schematic view showing a magnification pattern of a magnification generation module according to a second embodiment of the present invention;

FIG. 6B is a schematic view of a sensing unit of the magnification generation module of FIG. 6A according to the present invention;

FIG. 7 is a schematic view showing a magnification pattern of a magnification generation module according to a third embodiment of the present invention;

FIG. 8 is a block diagram of the sighting apparatus capable of displaying compensation position according to another embodiment of the present invention; and

FIGS. 9A-9C are schematic views illustrating fields of visions of the sighting apparatus of FIG. 9 according to one embodiment of the present invention.

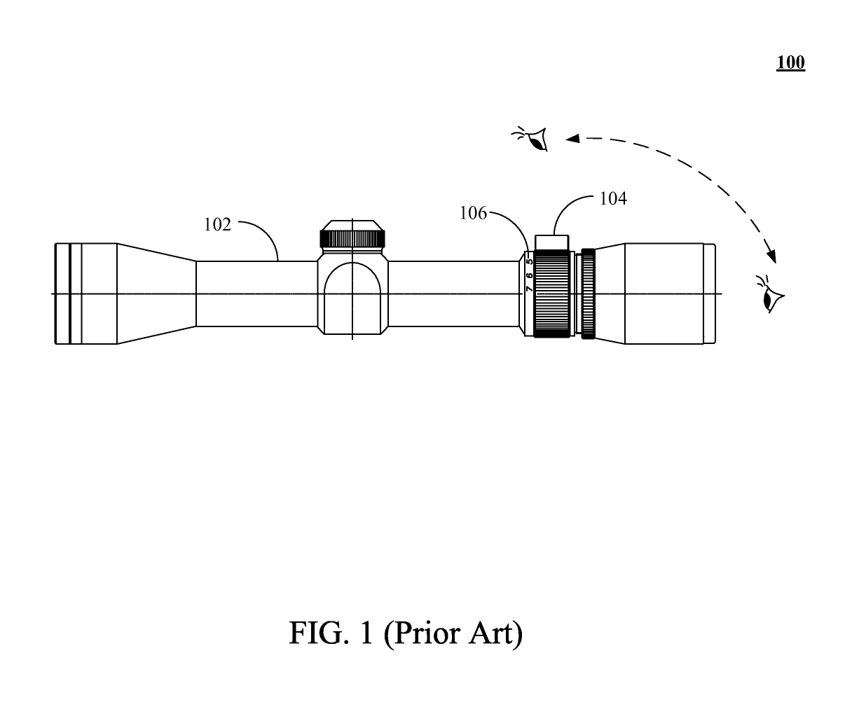

### DETAILED DESCRIPTION OF THE PREFERRED EMBODIMENTS

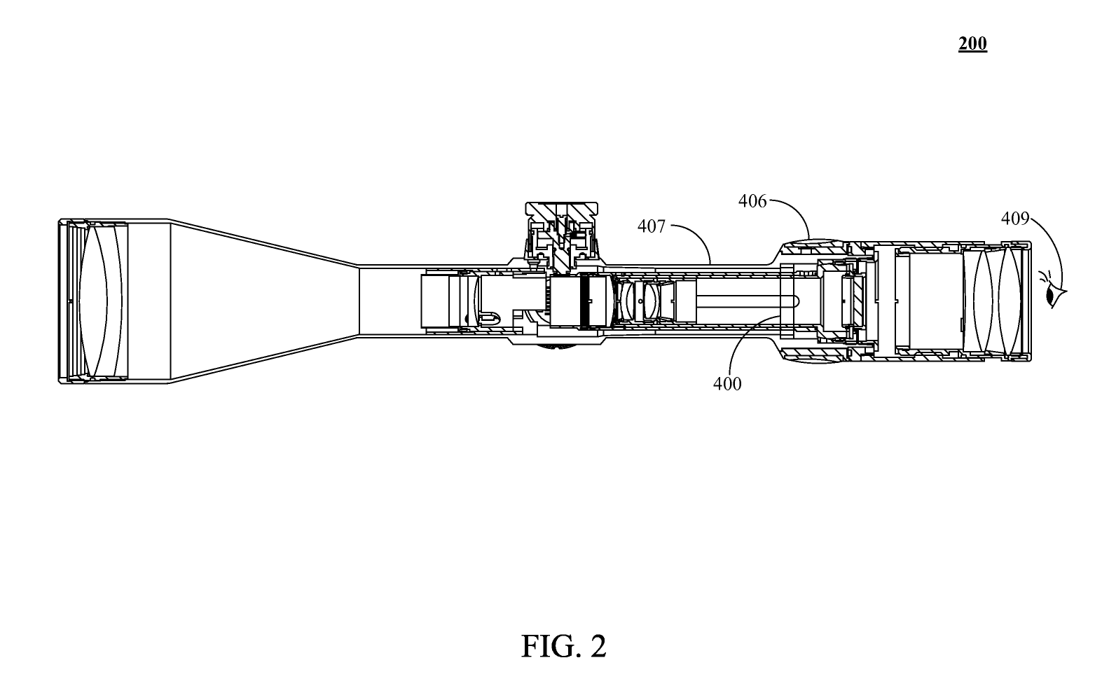

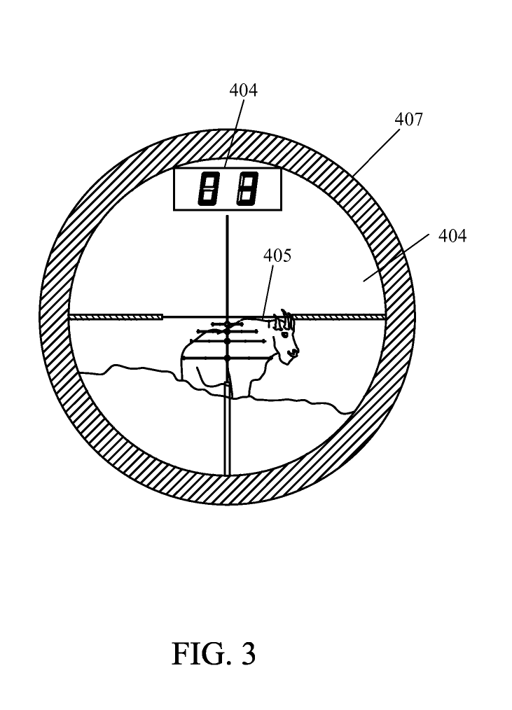

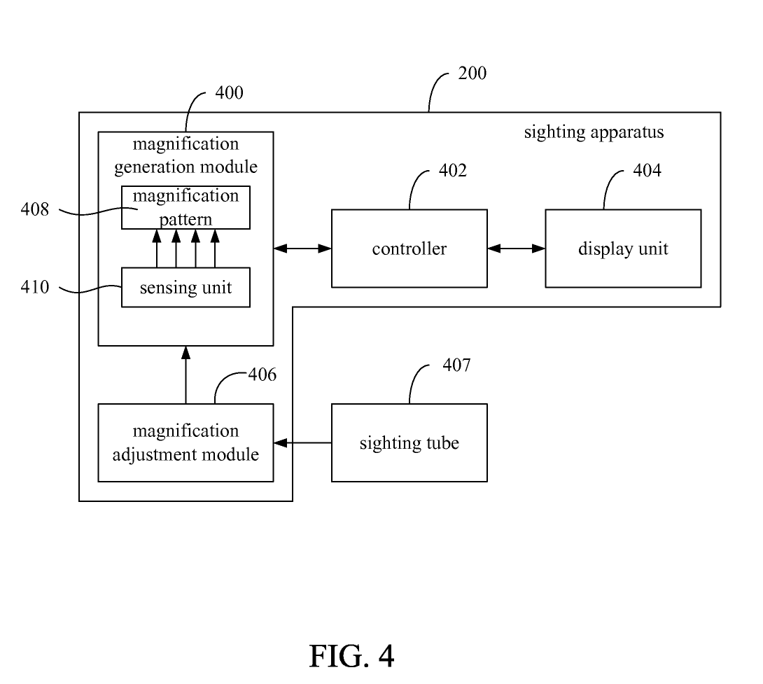

With reference to FIG. 2, which is a cross-sectional view of a sighting apparatus 200 capable of displaying magnification according to an embodiment of the present invention, and FIG. 3, which is a schematic view showing a field of vision sighted with the sighting apparatus 200 of the present invention shown in FIG. 2, the sighting apparatus 200 generally comprises a magnification generation module 400, a controller 402 (particularly shown in FIG. 4), a display unit 404 (particularly shown in FIG. 3), and a magnification adjustment module 406. The magnification adjustment module 406 is mounted on a sighting tube 407 to serve as a user operated adjustment measure for adjusting the magnification value of the sighting apparatus 200. When the user's eye 409 sights a target 405, for example, a prey animal, the current magnification value is simultaneously displayed in the field of vision of the sighting apparatus 200. Therefore, the problem that the user must remove his or her eye from the field of vision of an existing sighting apparatus before he or she can check the currently applied magnification can be overcome with the sighting apparatus 200 of the present invention and losing of sighting of the target due to the movement of eye is eliminated and aiming precision can be maintained and enhanced.

FIG. 4 is a block diagram of the sighting apparatus 200 capable of displaying magnification according to an embodiment of the present invention. The sighting apparatus 200 generally comprises a magnification generation module 400, a controller 402, a display unit 404, and a magnification adjustment module 406. The sighting apparatus 200 is mounted on a sighting tube 407. The magnification generation module 400 is coupled to the magnification adjustment module of the sighting apparatus 200 and the magnification generation module 400 comprises a magnification pattern 408 and a sensing unit 410. The magnification pattern 408 is composed of a plurality of magnification values. When the magnification adjustment module 406 is operated for adjustment, the magnification pattern 408 is caused to move and thus change the magnification value corresponding to the operation of the magnification adjustment module 406, and the magnification pattern 408 is then detected by the sensing unit 410 to retrieve the current magnification value from the magnification pattern 408. The sensing unit 410 also generates a magnification signal corresponding to the current magnification value. In one embodiment, the magnification adjustment module 406 is constructed as a rotatable magnification adjustment ring encompassing an outer circumference of the sighting tube 407. To operate, the rotatable magnification adjustment ring is rotated to change the magnification of the sighting apparatus. The controller 402 is coupled to the magnification generation module 400 for transforming the magnification signal. The display unit 404 is coupled to the controller 402 to receive the transformed magnification signal and display the current magnification value.

In one embodiment, the controller 402 may be for example a micro control unit (MCU), a digital signal processor (DSP), a central processing unit (CPU), a complex programmable logic device (CPLD), a field programmable gate array (FPGA), and/or a system on-chip (SOP), and/or any combination thereof The display unit 404 may be for example a seven-segment display consisting of light-emitting diodes (LEDs), a liquid crystal display, or any suitable displaying devices. In one embodiment, the seven-segment display may be for example directly disposed on an optical focal plane of the sighting apparatus 200, or alternatively, the magnification value displayed by the seven-segment display is projected to the optical focal plane of the sighting apparatus 200 through reflection projection, to thereby become visible in the field of vision of the sighting apparatus 200 and be seen by the user.

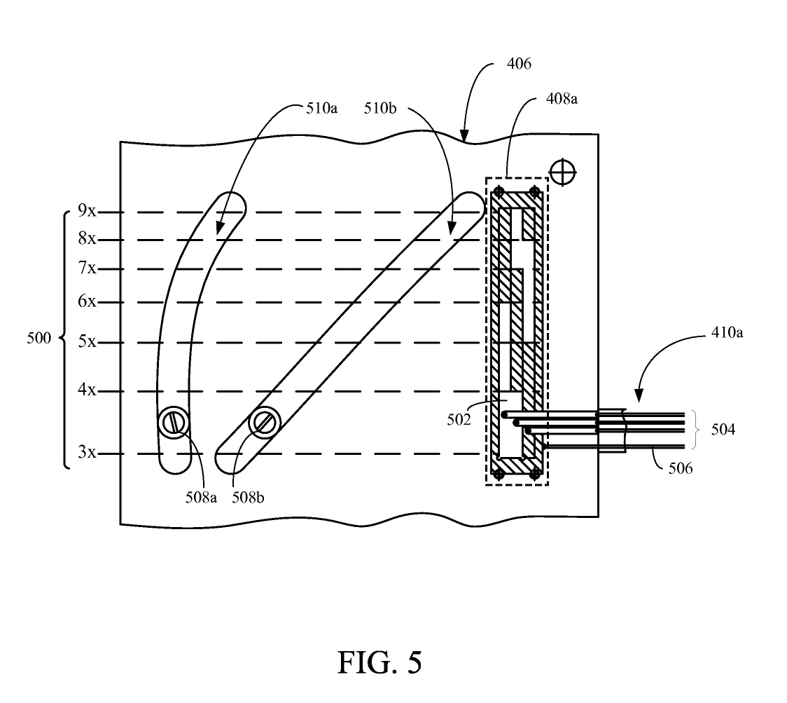

Referring to FIGS. 4 and 5, FIG. 5 is a schematic view of a magnification pattern 408a of the magnification generation module 400 according to a first embodiment of the present invention. The magnification pattern 408a is disposed in the magnification adjustment module 406. The magnification pattern 408a is composed of a plurality of magnification sections 500 and the magnification pattern 408a contains a plurality of magnification values. Each magnification section 500 corresponds to one of the magnification values. The magnification pattern 408a and the magnification adjustment module 406 are set in synchronization with each other for operation thereof In an embodiment, each magnification section 500 includes a plurality of electrode zones 502 and the magnification pattern 408a is constructed as an electrical conductive ring, such as a conductive metal ring.

A sensing unit 410a comprises a plurality of electrical conductive portions 504 and a grounding portion 506. Each conductive portion 504 is in an electrical contact with one corresponding electrode zone 502 of each magnification section 500, respectively, whereby the electrode portions 504 can detect the magnification signal. With each conductive portion 504 electrically engages the respective electrode zone 502 of one magnification section 500, a detection voltage level is formed between each conductive portion 504 and the grounding portion 506, and the detection voltage levels are combined to form the magnification signal. In FIG. 5, the magnification pattern 408a contains seven magnification sections respectively representing a magnification value from 3×to 9×.

In an embodiment, the sighting apparatus 200 comprises a first positioning dowel 508a and a second positioning dowel 508b, which are separately coupled to lens groups. With the magnification adjustment module 406 being embodied as a rotatable magnification adjustment ring, a first guiding groove 510a and a second guiding groove 510b are formed in the rotatable magnification adjustment ring and respectively receive the first positioning dowel 508a and the second positioning dowel 508b therein. When the rotatable magnification adjustment ring is rotated, the first guiding groove 510a and the second guiding groove 510b respectively guide movements of the first positioning dowel 508a and the second positioning dowel 508b to cause change of spacing between the two lens groups for realizing the change of magnification.

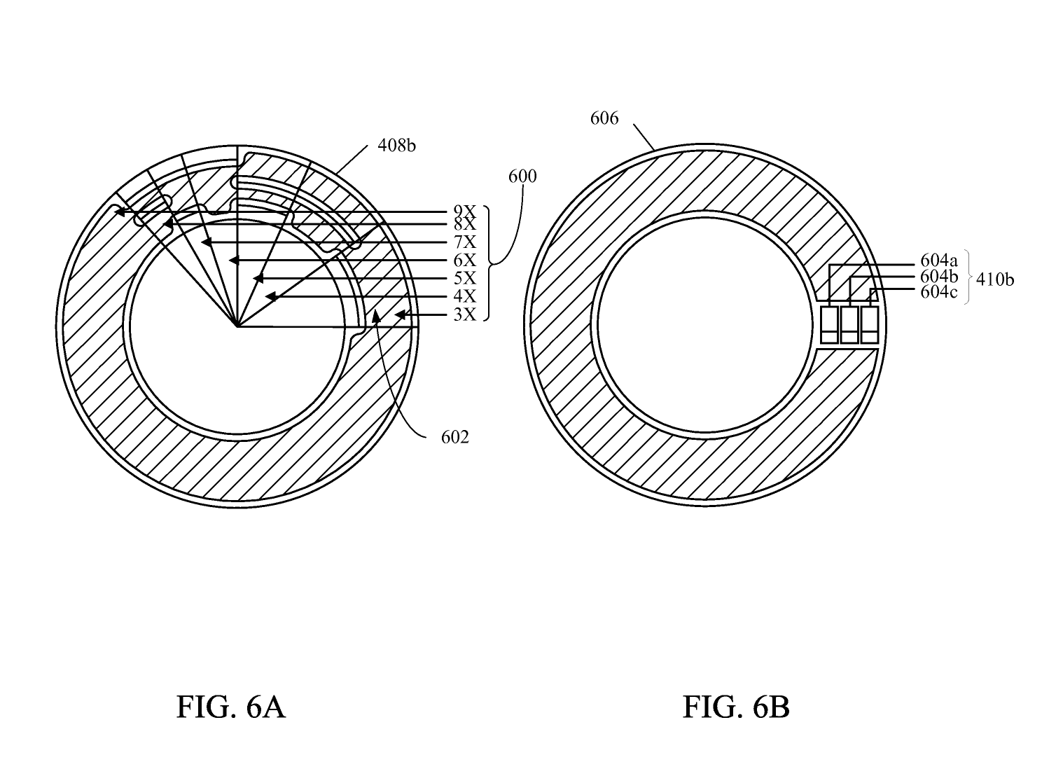

Referring to FIGS. 4, 6A and 6B, FIG. 6A is a schematic view of a magnification pattern 408b of the magnification generation module 400 according to a second embodiment of the present invention, and FIG. 6B is a schematic view of a sensing unit 410b of the magnification generation module 400 shown in FIG. 6A. The magnification pattern 408b is disposed in the magnification adjustment module 406. The magnification pattern 408b is composed of a plurality of magnification sections 600 and the magnification pattern 408b contains a plurality of magnification values. Each magnification section 600 corresponds to one of the magnification values. The magnification pattern 408b and the magnification adjustment module 406 are set in synchronization with each other for operation thereof. In an embodiment, each magnification section 600 includes a plurality of light/shade areas 602. The magnification pattern 408b is composed of a disc-shaped layer of material.

In the embodiment of FIG. 6A, the magnification pattern 408b contains for example seven magnification sections respectively representing a magnification value from 3× to 9×. Each magnification section 600 includes three light/shade areas 602. The light/shade areas 602 are constructed with for example a printed circuit board (PCB) 606 having light-transmitting portions and non-light-transmitting portions, wherein the light-transmitting portions form the light areas and the non-light-transmitting portions form the shade areas. In FIG. 6B, the sensing unit 410b comprises a plurality of light detection elements 604a, 604b, 604c. Each light detection element 604a, 604b, 604c corresponds to a respective light/shade area 602 of each magnification section 600, whereby a magnification signal can be detected by these light detection elements 604a, 604b, 604c.

When light enters the sighting apparatus 200 and travels through the magnification pattern 408b, the light detection elements 604a, 604b, 604c respectively detect the light/shade areas 602 of one magnification section 600, whereby the sensing unit 410b can obtain the magnification signal through the light detection element 604a, 604b, 604c. Here, the sensing unit 410b contains for example three detection elements 604a, 604b, 604c to respectively detect three light/shade areas 602. In one embodiment, the magnification pattern 408b is constructed as a disc-shaped layer of material and the disk-shaped layer of material moves synchronously with the magnification adjustment ring 406. The disc-shaped material layer and the magnification adjustment ring 406 rotate about a common axis of rotation. Moreover, the three detection elements 604a, 604b, 604c may be for example adhesively attached to a detection circuit board 606, whereby when the magnification adjustment ring 406 is rotated, the detection circuit board 606 is moved relative to the magnification pattern 408b for respectively detecting the three light/shade areas 602.

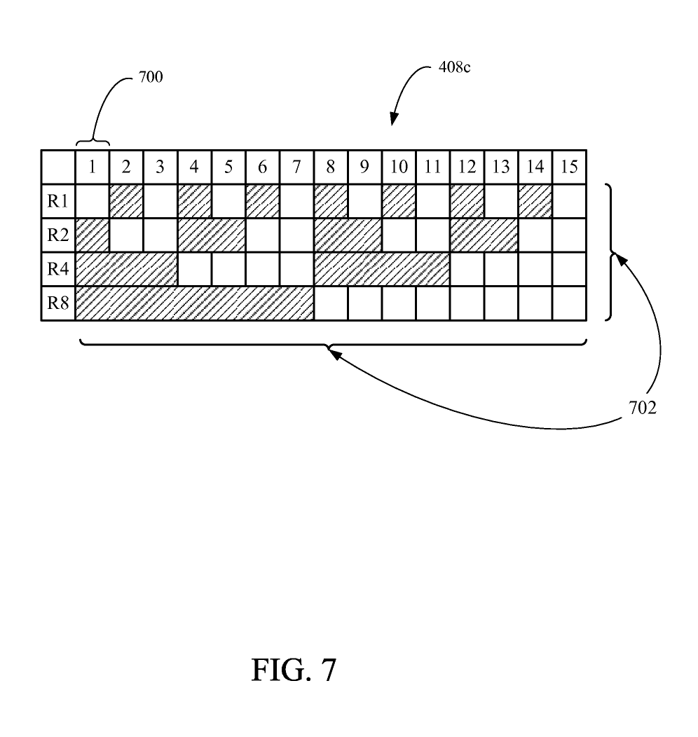

Referring to FIGS. 4 and 7, FIG. 7 is a schematic view of a magnification pattern 408c of the magnification generation module 400 according to a third embodiment of the present invention. The magnification pattern 408c is composed of a plurality of magnification sections 700 and the magnification pattern 408c contains a plurality of magnification values. The magnification pattern 408c is similar to the magnification pattern 408b of FIG. 6A, and a difference resides in that the magnification pattern 408c is constructed as a rectangular layer 702 of material forming a circumferential ring of patterns. The pattern ring is arranged to for example encompass and attach to the magnification adjustment ring 406. The numbers of 1 to 15 on the horizontal axis of FIG. 7 represent the magnification values of the sighting apparatus 200. The labels of R1-R2-R3-R4 on the vertical axis of FIG. 7 indicate numbering of the light detection elements employed to detect the magnification pattern 408c. Blank squares in FIG. 7 represent the light areas, meaning being light transmittable to allow the light detection elements to obtain a signal, and shaded squares represent the shade areas, which are light non-transmittable and prevent the light detection elements from obtaining a signal. In one embodiment, the light/shade areas are constructed with for example a printed circuit board (PCB) having light-transmitting portions and non-light-transmitting portions. The magnification pattern 408c is disposed in the magnification adjustment module 406 and is set in synchronization with the magnification adjustment module 406 for the operation thereof.

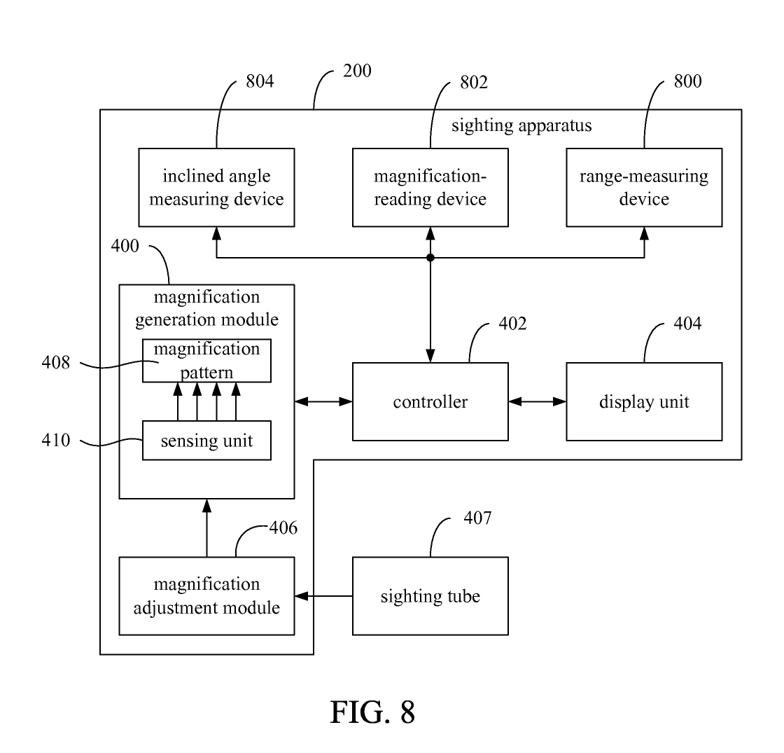

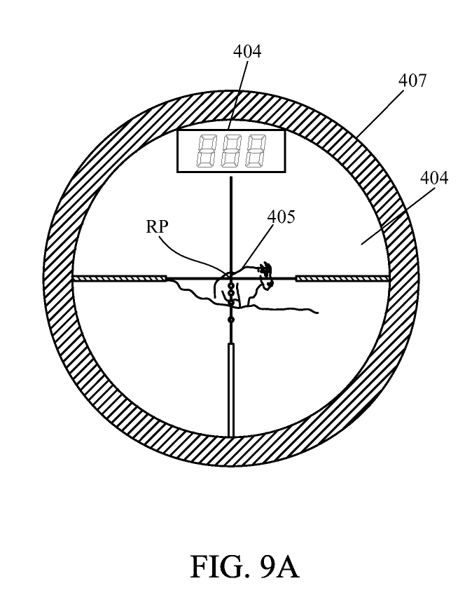

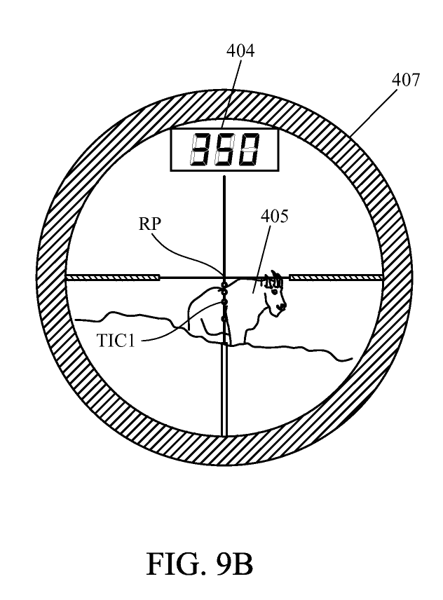

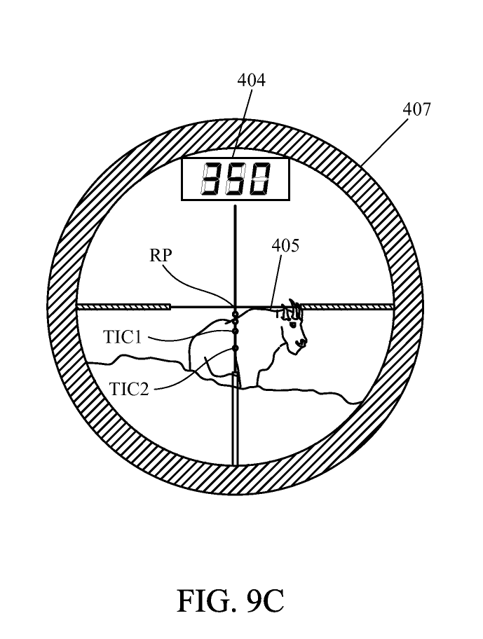

Referring to FIGS. 8 and 9A-9C, FIG. 8 is a block diagram of the sighting apparatus capable of displaying compensation position according to one embodiment of the present invention and FIGS. 9A-9C are schematic views illustrating fields of visions of the sighting apparatus of FIG. 9 according to one embodiment of the present invention.

The sighting apparatus 200 for sighting a target 405 includes a magnification adjustment module 406, a magnification generation module 400, a display unit 404, a controller 402, a range-measuring device 800, a magnification-reading device 802, and an inclined angle measuring device 804. The magnification generation module 400, the display unit 404, the range-measuring device 800, the magnification-reading device 802 and the inclined angle measuring device 804 are coupled to the controller 402 respectively.

The magnification adjustment module 406 is operated for adjusting magnification of the sighting apparatus 200. The magnification generation module 400 includes a magnification pattern for undergoing a movement of the magnification pattern in response to the operation of the magnification adjustment module 406. The magnification generation module 400 further includes a sensing unit 410 for detecting the magnification pattern to obtain a current magnification value and generates a magnification signal corresponding to the current magnification value. The display unit 404 is capable of displaying the target 405 in a reference position “RP” of the displaying unit 404 when the sighting apparatus 200 sights the target 405. As shown in FIG. 9A, the sighting apparatus 200 sights the target 405 in the reference position “RP” of the displaying unit 404 in the range distance, e.g. zero yards.

The controller 402 acquires a first compensation position TIC1 based on a range distance of the target 405 for computing a ratio of the current magnification value and a predetermined magnification value of the sighting apparatus 200, wherein the controller 402 generates a second compensation position TIC2 based on the first compensation position TIC1 and the ratio for displaying the second compensation position TIC2 in the display unit 404. In one embodiment, the predetermined magnification value is a maximum magnification value of the sighting apparatus 200, which is either greater than or equal to the current magnification value. In one preferred embodiment, the controller 402 multiplies the first compensation position TIC1 by the ratio for shifting the image of the target 405 from the reference position RP to the second compensation position TIC2 in the display unit 404.

That is, if the user makes a zoom in/out operation of the target 405 by either magnifying or minifying the magnification of the sighting apparatus 200, the controller 402 changes the first compensation position TIC1 in the display unit 404 to the second compensation position TIC2 and the second compensation position TIC2 is moved by the controller 402 either from the upper to the lower or from the lower to the upper in the display unit 404.

The range-measuring device 800 measures a range distance from the sighting apparatus 200 to the target 405 wherein the display unit 404 further displays the range distance. The magnification-reading device 800 reads the current magnification value of the sighting apparatus 200 in the reference position when an image of the target 405 is either magnified or minified. The magnification-reading device 800 further reads a predetermined magnification value of the sighting apparatus 200. The inclined angle measuring device 804 measures an inclination angle of the target 405 corresponding to the sighting apparatus 200 based on the range distance. Specifically, the inclination angle is defined as the angle between the horizontal direction and the sighting direction from the sighting apparatus 200 to the target 405.

Specifically, when the controller 402 acquires a first compensation position TIC1 based on a range distance of the target 405, the first compensation position is determined by the Table 1 listed below. In each item number (Ln #) of the Table 1, a first compensation position TIC1 is corresponding to a range distance interval. For example, the first compensation position TIC1 is “1” in the item number Ln 2 ranging from 116 yards to 128 yards, the first compensation position TIC1 is “14” in the item number Ln 15 ranging from 315 yards to 326 yards, and the first compensation position TIC1 is “32” in the item number Ln 33 ranging from 504 yards to 512 yards. It should be noted that the unit of distance range may be different length unit, e.g. meter, and the Table 1 of the sighting apparatus may be used in the equipment, e.g. gun, with the sighting apparatus. When the user chooses different kinds of guns or bullets used in the guns correspondingly, the corresponding relationship between the first compensation position and range distance may be changed.

TABLE 1

| | First compensation | Range from | Range to |
|---|---|---|---|
| Item number (Ln #) | position (TIC 1) | (Yards) | (Yards) |
| 1 | 0 | 0 | 115 |
| 2 | 1 | 116 | 128 |
| . | . | . | . |
| . | . | . | . |
| . | . | . | . |
| 15 | 14 | 315 | 326 |
| 16 | 15 | 327 | 338 |
| 17 | 16 | 339 | 350 |
| 18 | 17 | 351 | 361 |
| 19 | 18 | 362 | 373 |
| . | . | . | . |
| . | . | . | . |
| . | . | . | . |
| 31 | 30 | 486 | 494 |
| 32 | 31 | 495 | 503 |
| 33 | 32 | 504 | 512 |
| 34 | 33 | 513 | 521 |

In one case, as shown in FIG. 9B, the controller 402 acquires a first compensation position TIC1 “16” based on a range distance, 350 yards, of the target 405 for computing a ratio of the current magnification value, 4 times (4×), and the maximum magnification value, 16 times (16×), of the sighting apparatus 200. Thus, the second compensation position TIC2 is 4 calculated by the formula: 16*(4/16)=4.

If the current magnification value is 8 times (8×), the second compensation position TIC2 is 8 calculated by the formula: 16*(8/16)=8, as shown in FIG. 9C.

Based on the above description, the sighting apparatus capable of displaying magnification as provided by the present invention comprises a magnification generation module that comprises a magnification pattern and a sensing unit. When the magnification adjustment module drives the magnification pattern to carry out adjustment, the sensing unit detects the magnification pattern to obtain the current magnification value among those magnification values and generate a magnification signal corresponding to the current magnification value for immediately displaying the current magnification value in a field of vision of the sighting apparatus. In this way, the problem that the user must remove his or her eye from the field of vision of an existing sighting apparatus in order to get aware of the magnification value is completely overcome. Further, the sighting apparatus is capable of immediately displaying the displaying compensation position in a field of vision of the sighting apparatus, whereby convenience of sighting can be enhanced.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A sighting apparatus for sighting a target, the sighting apparatus comprising:
a magnification adjustment module, which is operated for adjusting magnification of the sighting apparatus;
a magnification generation module, which comprises a magnification pattern for undergoing a movement of the magnification pattern in response to the operation of the magnification adjustment module, and a sensing unit for detecting the magnification pattern to obtain a current magnification value and generates a magnification signal corresponding to the current magnification value;
a display unit, for displaying the target in a reference position of the displaying unit when the sighting apparatus sights the target; and
a controller coupled to the magnification generation module and the display unit respectively, for acquiring a first compensation position based on a range distance of the target, and for computing a ratio of the current magnification value and a predetermined magnification value of the sighting apparatus, wherein the controller generates a second compensation position based on the first compensation position and the ratio for displaying the second compensation position in the display unit.

2. The sighting apparatus as claimed in claim 1, wherein the magnification pattern and the magnification adjustment module are synchronously movable with each other, and the magnification adjustment module comprises a rotatable magnification adjustment ring.

3. The sighting apparatus as claimed in claim 1, wherein the magnification pattern comprises a plurality of magnification sections, each corresponding to a value of the magnification.

4. The sighting apparatus as claimed in claim 3, wherein each of the magnification sections comprises a plurality of electrode zones.

5. The sighting apparatus as claimed in claim 1, wherein the magnification pattern comprises an electrically conductive ring.

6. The sighting apparatus as claimed in claim 1, further comprising a controller coupled to the magnification generation module for transformation of the magnification signal corresponding to the current magnification value without displaying in a display unit.

7. The sighting apparatus as claimed in claim 1, further comprising a display unit, which displays the current magnification value corresponding to the magnification signal, wherein the display unit is disposed on an optical focal plane of the sighting apparatus.

8. The sighting apparatus as claimed in claim 1, further comprising:
a range-measuring device, for measuring a range distance from the sighting apparatus to the target; and
a magnification-reading device, for reading the current magnification value of the sighting apparatus in the reference position when an image of the target is either magnified or minified, and for reading a predetermined magnification value of the sighting apparatus.

9. The sighting apparatus as claimed in claim 1, wherein the display unit further displays the range distance.

10. The sighting apparatus as claimed in claim 1, further comprising an inclined angle measuring device coupled to the controller, for measuring an inclination angle of the target corresponding to the sighting apparatus based on the range distance.

11. The sighting apparatus as claimed in claim 1, wherein the predetermined magnification value is a maximum magnification value of the sighting apparatus, which is either greater than or equal to the current magnification value.

12. The sighting apparatus as claimed in claim 1, wherein the controller multiplies the first compensation position by the ratio for shifting the image of the target from the reference position to the second compensation position in the display unit.
